(19) United States
(12) Patent Application Publication
(10) Pub. No.: US 2003/0088614 A1
(43) Pub. Date: May 8, 2003

(54) Directory server mapping tree

(76) Inventors: Gilles Bellaton, St. Martin d'Heres (FR); Robey Pointer, Mountain View, CA (US); Mark C. Smith, Saline, MI (US)

Correspondence Address: ROSENTHAL & OSHA L.L.P., 1221 MCKINNEY AVENUE, SUITE 2800, HOUSTON, TX, 77010, US

(21) Appl. No.: 09/993,919

(22) Filed: Nov. 6, 2001

(51) Int. Cl. G06F 15/16; G06F 17/30; G06F 7/00

(52) U.S. Cl. 709/203; 707/10

(57) ABSTRACT

A directory server including a supplier server, a consumer server in communication with the supplier server, a plurality of pluggable services that manage replication of data contained within the directory server from the supplier server to the consumer server, and a directory server mapping tree used to select a backend to handle a request. Replication of data is managed using the directory server mapping tree.

### BACKGROUND OF THE INVENTION

The most fundamental program resident on any computer is the operating system (OS). Various operating systems exist in the market place, including Solaris™ from Sun Microsystems Inc., Palo Alto, Calif. A (Sun Microsystems), MacOS from Apple Computer, Inc., Cupertino, Calif., Windows® 95/98 and Windows NT®, from Microsoft Corporation, Redmond, Wash., UNIX, and Linux. The combination of an OS and its underlying hardware is referred to herein as a “traditional platform”. Prior to the popularity of the Internet, software developers wrote programs specifically designed for individual traditional platforms with a single set of system calls and, later, application program interfaces (APIs). Thus, a program written for one platform could not be run on another. However, the advent of the Internet made cross-platform compatibility a necessity and a broader definition of a platform has emerged. Today, the original definition of a traditional platform (OS/hardware) dwells at the lower layers of what is commonly termed a “stack,” referring to the successive layers of software required to operate in the environment presented by the Internet and World Wide Web.

Effective programming at the application level requires the platform concept to be extended all the way up the stack, including all the new elements introduced by the Internet. Such an extension allows application programmers to operate in a stable, consistent environment.

iPlanet™ E-commerce Solutions, a Sun Microsystems|Netscape Alliance, has developed a net-enabling platform shown in FIG. 1 called the Internet Service Deployment Platform (ISDP) (28). ISDP (28) gives businesses a very broad, evolving, and standards-based foundation upon which to build an e-enabled solution.

A core component of the ISDP (28) is iPlanet™ Directory Server (80), a Lightweight Directory Access Protocol (LDAP)-based solution that can handle more than 5,000 queries per second. iPlanet™ Directory Server (iDS) provides a centralized directory service for an intranet or extranet while integrating with existing systems. The term “directory service” refers to a collection of software, hardware, and processes that store information and make the information available to users. The directory service generally includes at least one instance of the iDS and one or more directory client program(s). Client programs can access names, phone numbers, addresses, and other data stored in the directory.

The iDS is a general-purpose directory that stores all information in a single, network-accessible repository. The iDS provides a standard protocol and application programming interface (API) to access the information contained by the iDS. The iDS provides global directory services, meaning that information is provided to a wide variety of applications. Until recently, many applications came bundled with a proprietary database. While a proprietary database can be convenient if only one application is used, multiple databases become an administrative burden if the databases manage the same information. For example, in a network that supports three different proprietary e-mail systems where each system has a proprietary directory service, if a user changes passwords in one directory, the changes are not automatically replicated in the other directories. Managing multiple instances of the same information results in increased hardware and personnel costs.

The global directory service provides a single, centralized repository of directory information that any application can access. However, giving a wide variety of applications access to the directory requires a network-based means of communicating between the numerous applications and the single directory. The iDS uses LDAP to give applications access to the global directory service.

LDAP is the Internet standard for directory lookups, just as the Simple Mail Transfer Protocol (SMTP) is the Internet standard for delivering e-mail and the Hypertext Transfer Protocol (HTTP) is the Internet standard for delivering documents. Technically, LDAP is defined as an on-the-wire bit protocol (similar to HTTP) that runs over Transmission Control Protocol/Internet Protocol (TCP/IP). LDAP creates a standard way for applications to request and manage directory information.

An LDAP-compliant directory, such as the iDS, leverages a single, master directory that owns all user, group, and access control information. The directory is hierarchical, not relational, and is optimized for reading, reliability, and scalability. This directory becomes the specialized, central repository that contains information about objects and provides user, group, and access control information to all applications on the network. For example, the directory can be used to provide information technology managers with a list of all the hardware and software assets in a widely spanning enterprise. Most importantly, a directory server provides resources that all applications can use, and aids in the integration of these applications that have previously functioned as stand-alone systems. Instead of creating an account for each user in each system the user needs to access, a single directory entry is created for the user in the LDAP directory. FIG. 2 shows a portion of a typical directory with different entries corresponding to real-world objects. The directory depicts an organization entry (90) with the attribute type of domain component (dc), an organizational unit entry (92) with the attribute type of organizational unit (ou), a server application entry (94) with the attribute type of common name (cn), and a person entry (96) with the attribute type of user ID (uid). All entries are connected by the directory.

Understanding how LDAP works starts with a discussion of an LDAP protocol. The LDAP protocol is a message-oriented protocol. The client constructs an LDAP message containing a request and sends the message to the server. The server processes the request and sends a result, or results, back to the client as a series of LDAP messages. Referring to FIG. 3, when an LDAP client (100) searches the directory for a specific entry, the client (100) constructs an LDAP search request message and sends the message to the LDAP server (102) (step 104). The LDAP server (102) retrieves the entry from the database and sends the entry to the client (100) in an LDAP message (step 106). A result code is also returned to the client (100) in a separate LDAP message (step 108).

LDAP-compliant directory servers like the iDS have nine basic protocol operations, which can be divided into three categories. The first category is interrogation operations, which include search and compare operators. These interrogation operations allow questions to be asked of the directory. The LDAP search operation is used to search the directory for entries and retrieve individual directory entries. No separate LDAP read operation exists. The second category is update operations, which include add, delete, modify, and modify distinguished name (DN), i.e., rename, operators. A DN is a unique, unambiguous name of an entry in LDAP. These update operations allow the update of information in the directory. The third category is authentication and control operations, which include bind, unbind, and abandon operators.

The bind operator allows a client to identify itself to the directory by providing an identity and authentication credentials. The DN and a set of credentials are sent by the client to the directory. The server checks whether the credentials are correct for the given DN and, if the credentials are correct, notes that the client is authenticated as long as the connection remains open or until the client re-authenticates. The unbind operation allows a client to terminate a session. When the client issues an unbind operation, the server discards any authentication information associated with the client connection, terminates any outstanding LDAP operations, and disconnects from the client, thus closing the TCP connection. The abandon operation allows a client to indicate that the result of an operation previously submitted is no longer of interest. Upon receiving an abandon request, the server terminates processing of the operation that corresponds to the message ID.

In addition to the three main groups of operations, the LDAP protocol defines a framework for adding new operations to the protocol via LDAP extended operations. Extended operations allow the protocol to be extended in an orderly manner to meet new marketplace needs as they emerge.

The basic unit of information in the LDAP directory is an entry, a collection of information about an object. Entries are composed of a set of attributes, each of which describes one particular trait of an object. Attributes are composed of an attribute type (e.g., common name (cn), surname (sn), etc.) and one or more values. FIG. 4 shows an exemplary entry (124) showing attribute types (120) and values (122). Attributes may have constraints that limit the type and length of data placed in attribute values (122). A directory schema places restrictions on the attribute types (120) that must be, or are allowed to be, contained in the entry (124).

### SUMMARY OF INVENTION

In general, in one aspect, the invention involves a directory server. The directory comprises a supplier server, a consumer server in communication with the supplier server, a plurality of pluggable services that manage replication of data contained within the directory server from the supplier server to the consumer server, and a directory server mapping tree used to select a backend to handle a request. Replication of data is managed using the directory server mapping tree.

In general, in one aspect, the invention involves a method for selecting a backend using a directory server mapping tree. The method comprises providing a search criteria by a client application, initiating a search request by the directory server mapping tree, searching the directory server mapping tree using the search criteria, and selecting the backend mapped in the directory server mapping tree that matches the search criteria.

In general, in one aspect, the invention involves a method for selecting a backend using a directory server mapping tree. The method comprises providing a search criteria by a client application, initiating a search request by the directory server mapping tree, searching the directory server mapping tree using the search criteria, selecting the backend mapped in the directory server mapping tree that w matches the search criteria, traversing the directory server mapping tree for each request initiated by the client application, determining a node that most resembles the search criteria provided by the client application, modifying the directory server mapping tree from a plugin without dependence on node representation, and selecting a closest match based on the search criteria, if an exact match is not found.

In general, one aspect, the invention involves an apparatus for selecting a backend using a directory server mapping tree. The apparatus comprises means for providing a search criteria by a client application, means for initiating a search request by the directory server mapping tree, means for searching the directory server mapping tree using the search criteria, and means for selecting the backend mapped in the directory server mapping tree that matches the search criteria.

Other aspects and advantages of the invention will be apparent from the following description and the appended claims.

### BRIEF DESCRIPTION OF DRAWINGS

FIG. 1 illustrates a block diagram of iPlanet™ Internet Service Development Platform.

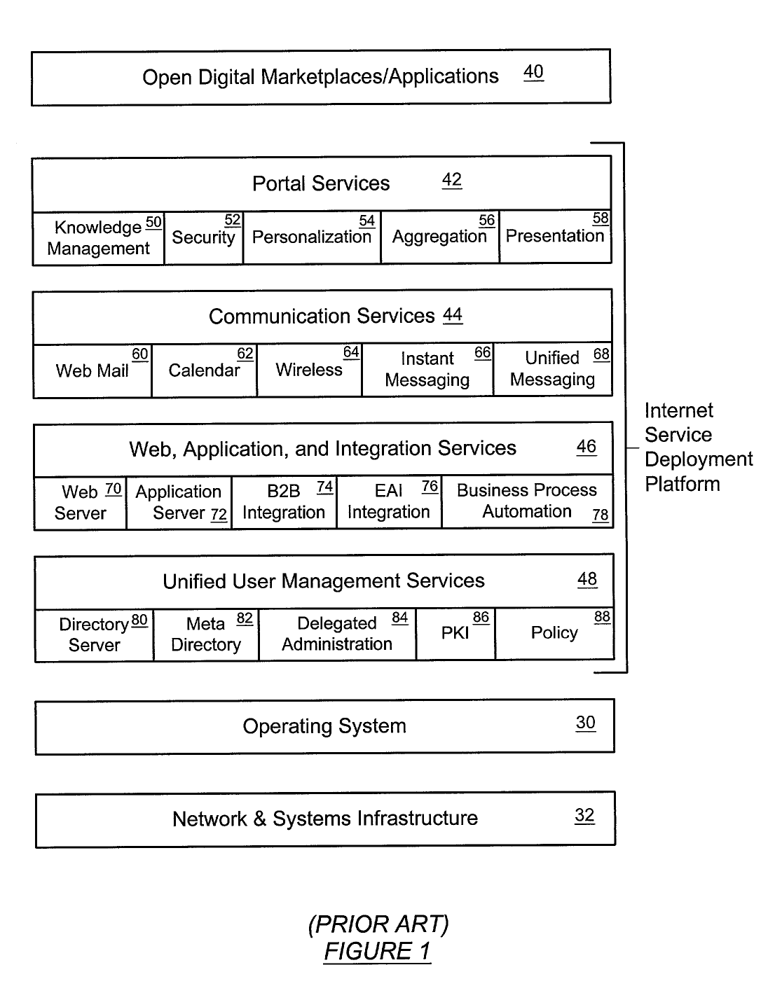

FIG. 2 illustrates part of a typical directory.

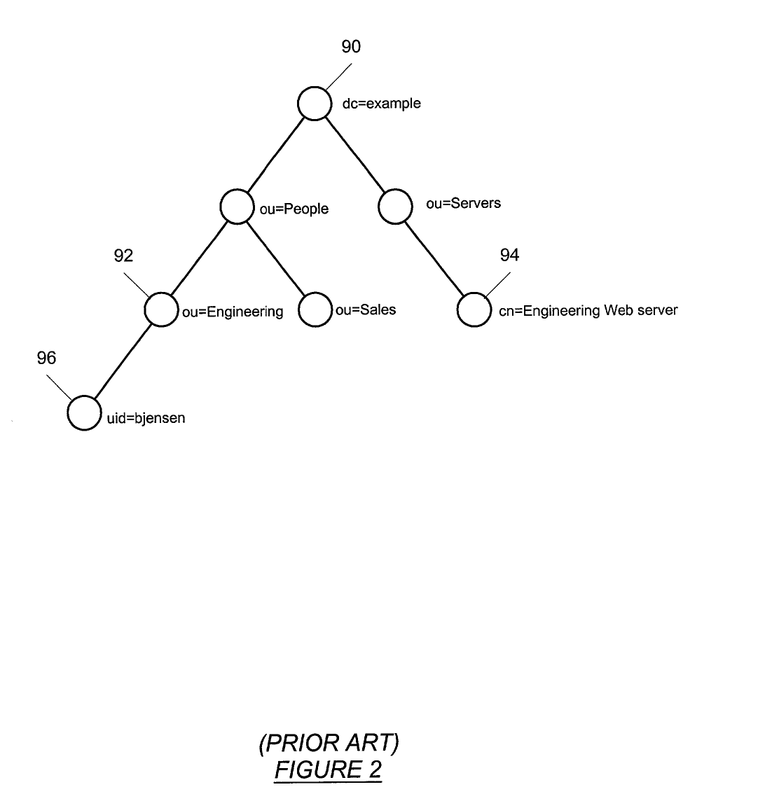

FIG. 3 illustrates the LDAP protocol used for a simple request.

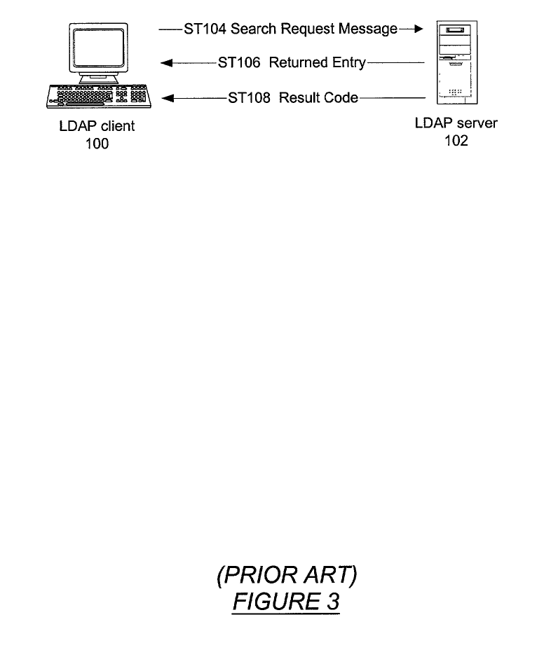

FIG. 4 illustrates a directory entry showing attribute types and values.

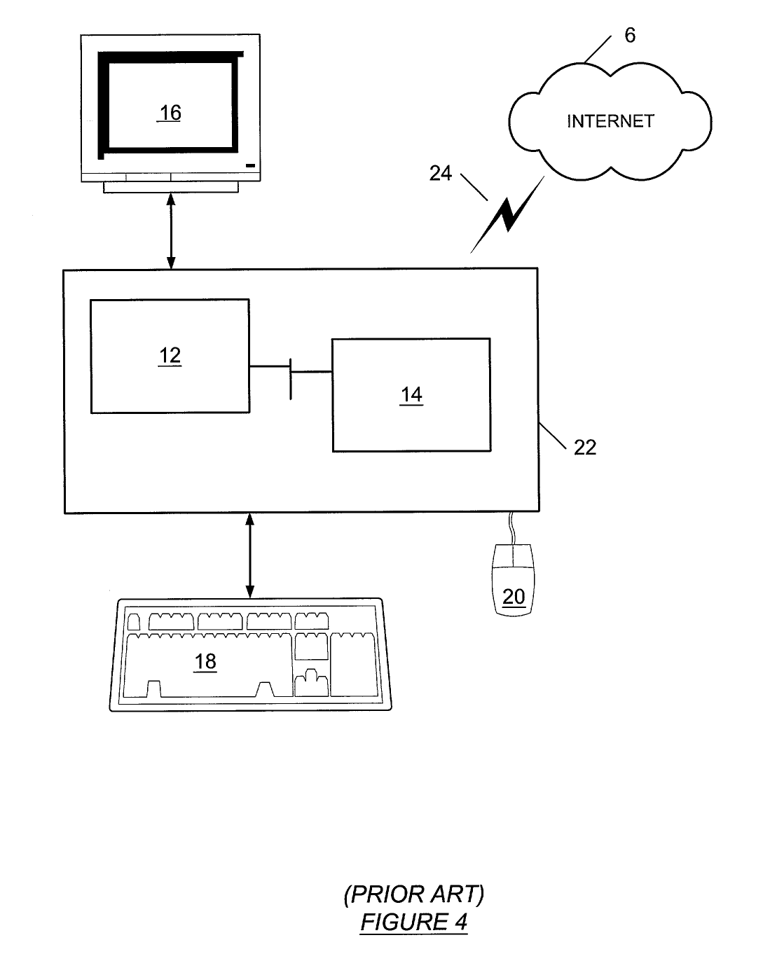

FIG. 5 illustrates a typical computer with components.

FIG. 6 illustrates an default DIT.

FIG. 7 illustrates an example DIT.

FIG. 8 illustrates a typical example of how the DIT is stored in different backends.

FIG. 9 illustrates the typical steps involved in searching a DIT using DSMT.

FIG. 10 illustrates a flow process in accordance with one or more embodiments of the present invention.

### DETAILED DESCRIPTION

Specific embodiments of the invention will now be described in detail with reference to the accompanying figures. Like elements in the various figures are denoted by like reference numerals for consistency.

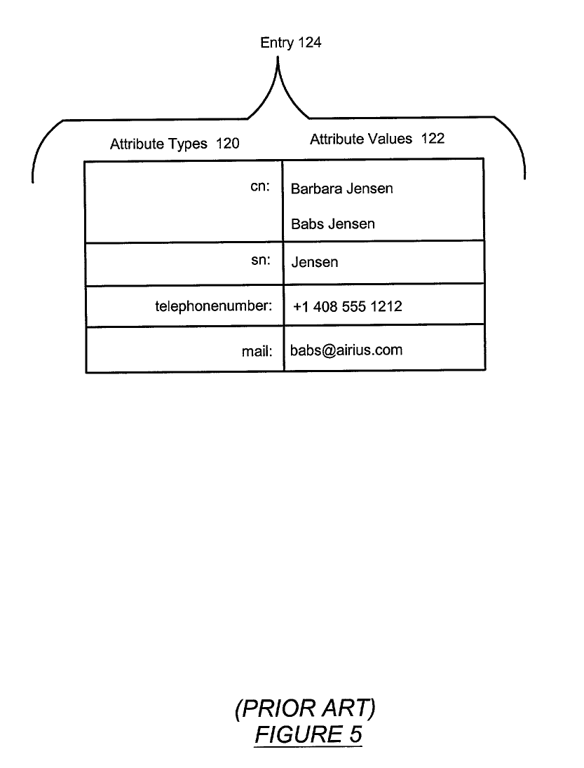

The invention described here may be implemented on virtually any type computer regardless of the traditional platform being used. For example, as shown in FIG. 5, a typical computer (130) has a processor (132), memory (134), among others. The computer (130) has associated therewith input means such as a keyboard (136) and a mouse (138), although in an accessible environment these input means may take other forms. The computer (130) is also associated with an output device such as a display (140), which also may take a different form in a given accessible environment. The computer (130) is connected via a connection means (142) to a wide area network (144), such as the Internet.

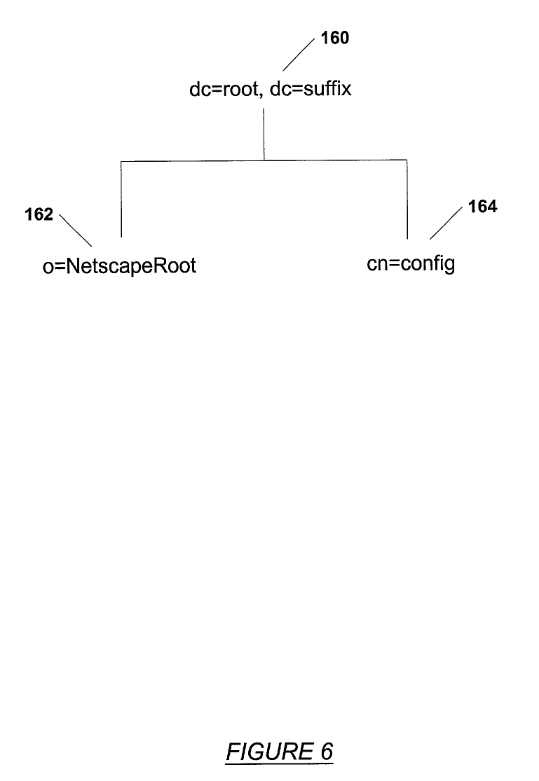

A basic directory tree, also known as directory information tree (DIT), mirrors a tree model used by most file systems, with a tree root, or first entry, appearing at the top of a hierarchy. At installation, the iDS creates a default directory tree as show in FIG. 6. The default directory tree contains a root (160) (dc=root, dc=suffix) and two entries. A first entry is o=NetscapeRoot (162). The data contained by this subtree is used by the iPlanet™ Administration Server. The iPlanet™ Administration Server handles authentication, and all actions that cannot be performed through LDAP (such as starting or stopping). A second entry is cn=config (164). This subtree contains iDS configuration information.

The initial directory tree contains one subtree reserved for the server itself and one subtree for iPlanet™ Administration Server. All the iDS typically contain the cn=config data, but only one (the first server installed) contains the o=NetscapeRoot information. The default directory can be built upon to add any data relevant to a directory installation.

A Directory Server Mapping Tree (DSMT) is a method and a tool for selecting a backend to handle a request. A backend is a server, storage medium where data is stored in a retrievable fashion. A request is a query to a server to perform an LDAP operation. The LDAP operation may involve selecting multiple backends, requiring the DSMT to pick which backends to use. The DSMT is a mapping from subtrees in the DIT to backends. A node in the DSMT represents a subtree in the DIT. The node is stored as an entry in the DSMT as well as an entry in the DIT.

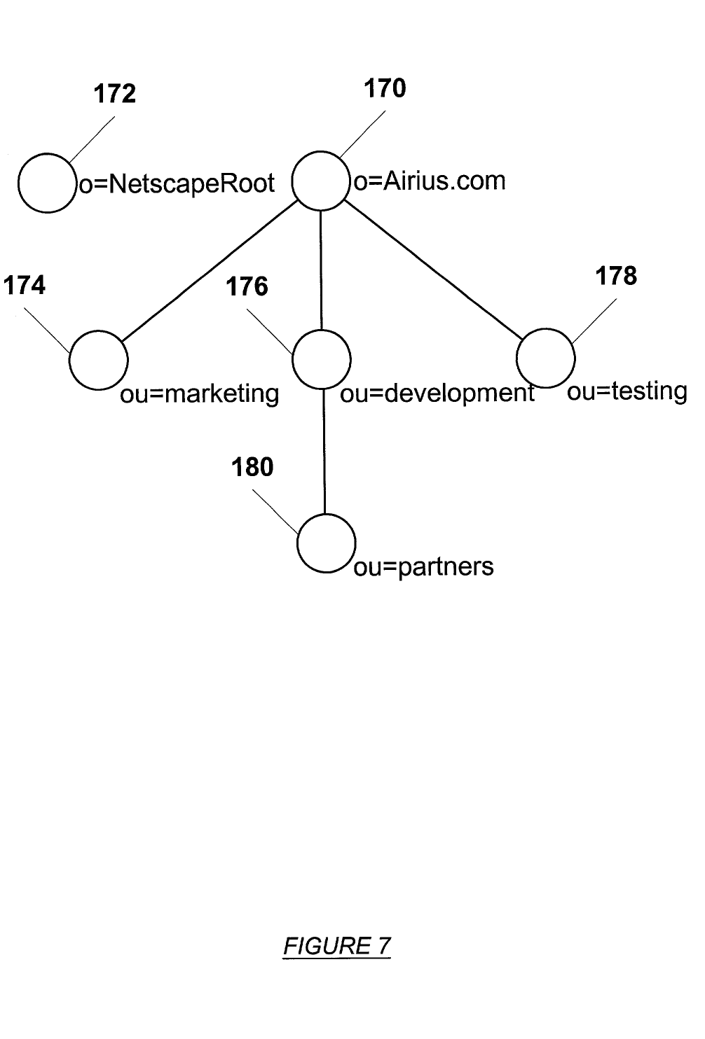

Each entry in the DIT is searched for each search initiated by a client application. FIG. 7 illustrates an example DIT. A search of this example DIT involves comparing every entry with the search DN to determine if a match is made. Here, the following entries may be compared during the search: o=NetscapeRoot (172), o=Airius.com (170), ou=marketing (174), ou=development (176), ou=testing (178), and ou=partners (180). The results are then returned to the client application.

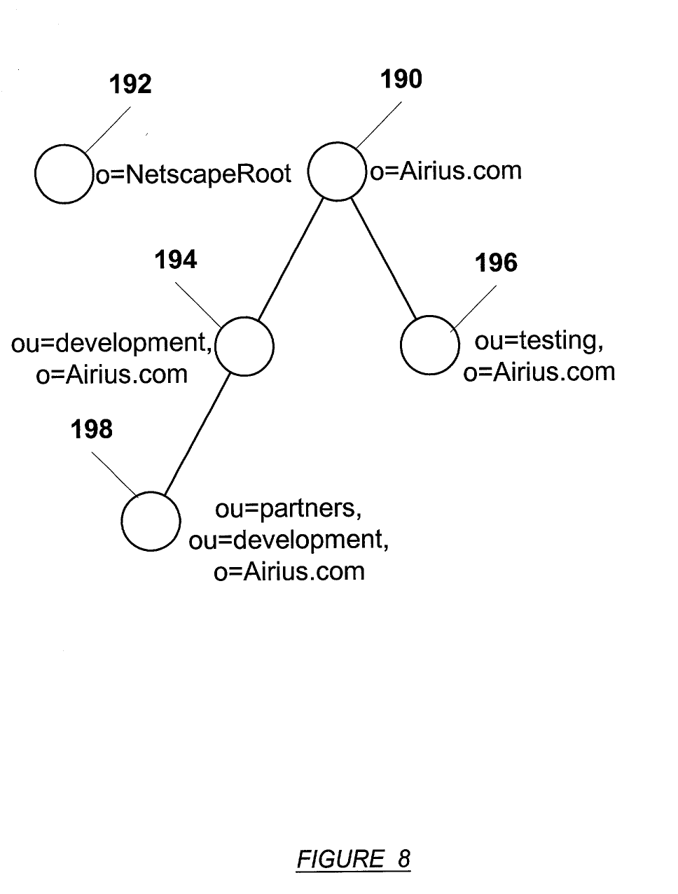

FIG. 8 illustrates a typical example of how the DSMT stores the DIT into different backends. A backend is created for o=NetscapeRoot (192). Another is made for o=Airius.com (190). Another backend for ou=development, o=Airius.com (194). Another backend for ou=testing, o=Airius.com (196). A final backend for this example DIT is made from ou=partners, ou=development, o=Airius.com (198).

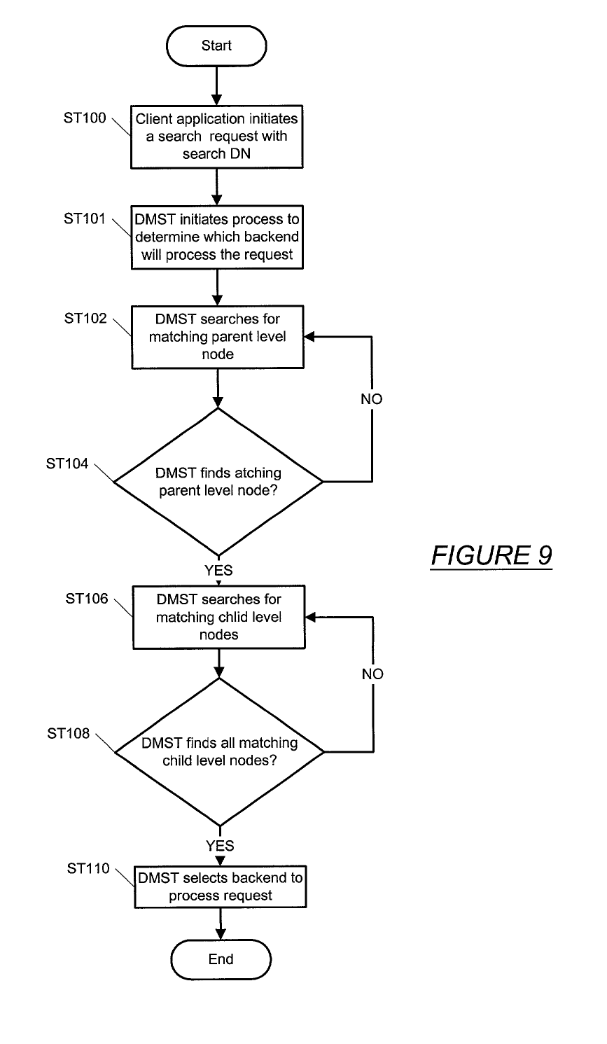

The DSMT is traversed for each LDAP operation the server performs. FIG. 9 illustrates the typical steps involved in searching a DIT using DSMT. A client application initiates a search request providing a search DM e.g., cn=John Doe, ou=testing, and o=Airius.com (Step 100). The DMST proceeds to find which backend will handle the request (Step 101). The objective is to find the backend that most closely matches the search DN. The DMST first compares the parent level nodes with the search DN i.e., the DMST attempts to find a backend with o=Airius.com (Step 102). If the parent level nodes do not match (Step 104) then the DMST continues to search for the parent level node with a matching DN. If the parent level nodes match the search DN (Step 104) then the DMST proceeds to search for child level nodes connected to the parent node that match the search DN i.e., the DMST looks for child level nodes with a DN of cn=John Doe, ou =testing (step 106). If all child level nodes do not match (Step 108) then the DMST continues to search for a set of child level nodes that match the search DN. If all child level nodes match the search DN (Step 108) then the DMST proceeds to selected the backend containing the parent and child level nodes specified in the search DN to handle the request (Step 110).

In one embodiments of the present invention if an exact match is not found that the closest match based on criteria specified by the client application or the DMST is selected to process the request. In one embodiment of the present invention the DMST determines the closest match by determining which of the backends contains the most number of matching parents and children. The backend with the most number of matching parents and children based on the search DN is selected to process the application. If two or more backends have the same number of matching parents and children then they are all returned to process the request.

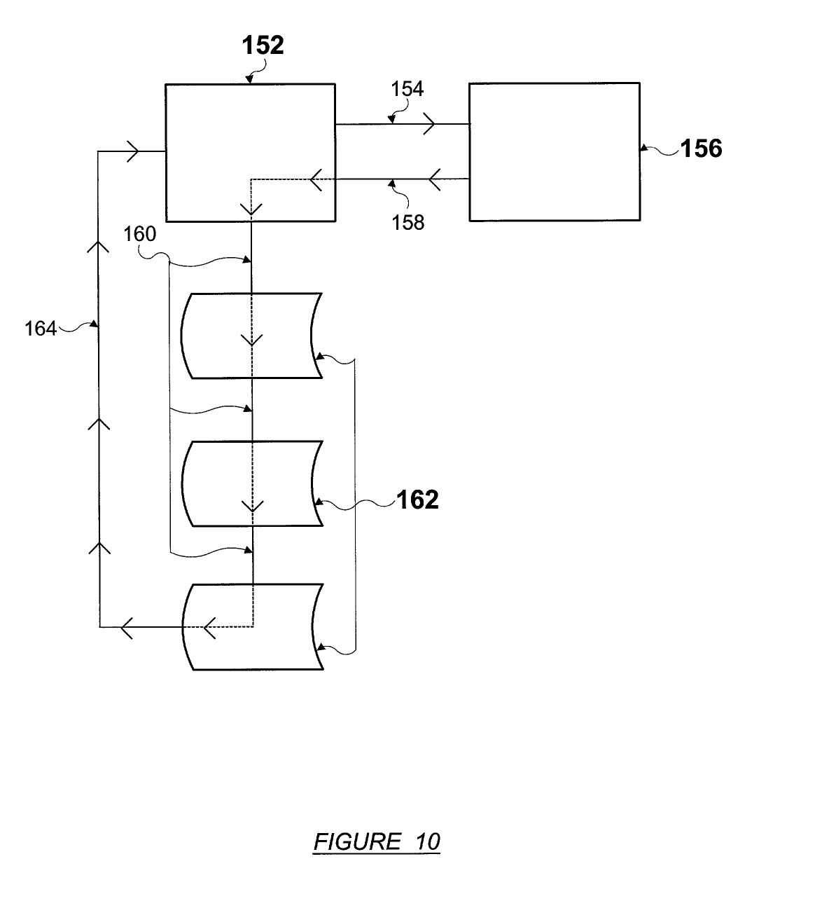

FIG. 10 illustrates a flow process of the DSMT (156) returning several backends (162) to handle a request (154), though those skilled in the art will recognize that the number of backends is variable and the process may be modified accordingly. In this figure, the LDAP client (152) sends a request (154) to the DSMT (156). The DSMT (156) determines which node most closely resembles the request (154), and returns a list (158) of the backend(s) (162) to handle the request (154). In this case, several backends (162) to handle the request (154) are returned (158). A successive search (160) of the list (158) is then initiated by the LDAP client (152). A sum of the results (164) of the successive search (160) is returned to the LDAP client (152) to resolve the request (154).

Each DSMT node has a state that is used to enable or disable a DSMT node. The state may also be used to specify that a referral must be sent, rather than performing the LDAP operation on the backend itself. A referral is an LDAP URL returned to the client when the server receives a request for an entry not belonging to the DIT. One state of a node is a backend state, where the node is enabled. Another state is a disabled state, where the node is disabled. A further state is a referral state, where a referral is sent back for any type of access.

Another state is a referral on update state, where a referral is sent back for an update LDAP operation, except for a replication LDAP operation.

Each node of the DSMT has an entry in the DIT under cn=mapping tree, cn=config, though those skilled in the art will recognize that these terms are variable, depending on implementation. In order to be recognized as DSMT entries, the entry in the DIT uses a nsMappingTree objectclass, though, again, those skilled in the art will recognize that this term is variable, depending on implementation.

The entries in the DIT that exist for the DSMT used in the previous example are as follows:

DN: cn=“o=Airius.com”, cn=mapping tree, cn=config

objectclass: nsMappingTree

nsslapd-backend: Airius.com

nsslapd-state: backend

DN: cn=“ou=testing, o=Airius.com”, cn=mapping tree, cn=config

objectclass: nsMappingTree

nsslapd-backend: testing

nsslapd-parent-suffix: o=Airius.com

nsslapd-state: backend

A DSMT entry root DN (i.e., cn=“ou=testing, o-Airius.com”) is the same root DN for the subtree of the root DN node, with quotes around it, though other embodiments of the present invention may not include the quotes, or include demarcation other than quotes. The root DN of the subtree is a suffix for the backend the node points to.

A DSMT application programming interface (API) allows modification of the DSMT from the server code or from a plugin, with no dependence on the node representation.

Advantages of the present invention may include one or more of the following. The DSMT allows for support of a multiple backend environment. The DSMT allows the server to easily determine which backends handle the request when a search spans multiple backends. Additionally, because the nodes are represented as entries in the DIT as well as in the DSMT, client applications may manipulate the DIT as needed. More information may also be added to the nodes to increase functionality, such as replacing a pointer to a backend with a referral when a backend needs to be taken down for maintenance. Another advantage of the present invention is that the node may also have any number of pointers to a backend, allowing the server to distribute requests in the same subtree over a number of backends. To determine which backend will be used to handle a request, different approaches may be implemented. One implementation is to have a plugin that determines which backend to use. In order to make that determination, the plugin needs to provide a function to pick, using some basis, the backend from a list of backends. The basis is determined by the entry DN, the time of day, the type of LDAP operation, or any number of other information. A further advantage is that a node of the DSMT is an extensible object. An extensible objects is one such that a plugin is able to attach information in the form of attributes to the node. This is useful when permanent storage of information is needed. Another advantage is that referrals may be sent back to the client application as a list. In other words, the DSMT need not choose from among the referrals if there is a list. Those skilled in the art will appreciate that the present invention may have further advantages.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A directory server comprising:
a supplier server;
a consumer server in communication with the supplier server;
a plurality of pluggable services that manage replication of data contained within the directory server from the supplier server to the consumer server; and
a directory server mapping tree used to select a backend to handle a request;
wherein replication of data is managed using the directory server mapping tree.

2. The directory server of claim 1, wherein the directory server mapping tree is traversed for each operation the consumer server performs.

3. The directory server of claim 1, wherein a node is determine that most resembles the search criteria provided by the client application.

4. The method of claim 3, wherein the node has a state enabling the directory server mapping tree.

5. The method of claim 3, wherein the node has a state disabling the directory server mapping tree.

6. The method of claim 3, wherein the node has an entry in the directory information tree.

7. A method for selecting a backend using a directory server mapping tree, comprising:
providing a search criteria by a client application;
initiating a search request by the directory server mapping tree;
searching the directory server mapping tree using the search criteria; and
selecting the backend mapped in the directory server mapping tree that matches the search criteria.

8. The method of claim 7, further comprising:
traversing the directory server mapping tree for each request initiated by the client application.

9. The method of claim 7, further comprising:
determining a node that most resembles the search criteria provided by the client application.

10. The method of claim 9, wherein the node has a state enabling the directory server mapping tree.

11. The method of claim 9, wherein the node has a state disabling the directory server mapping tree.

12. The method of claim 9, wherein the node has an entry in the directory information tree.

13. The method of claim 7, further comprising:
modifying the directory server mapping tree from a plugin without dependence on node representation.

14. The method of claim 7, further comprising:
selecting a closest match based on the search criteria, if an exact match is not found.

15. A method for selecting a backend using a directory server mapping tree, comprising:
providing a search criteria by a client application;
initiating a search request by the directory server mapping tree;
searching the directory server mapping tree using the search criteria;
selecting the backend mapped in the directory server mapping tree that matches the search criteria;
traversing the directory server mapping tree for each request initiated by the client application;
determining a node that most resembles the search criteria provided by the client application;
modifying the directory server mapping tree from a plugin without dependence on node representation; and
selecting a closest match based on the search criteria, if an exact match is not found.

16. An apparatus for selecting a backend using a directory server mapping tree, comprising:
means for providing a search criteria by a client application;
means for initiating a search request by the directory server mapping tree;
means for searching the directory server mapping tree using the search criteria; and
means for selecting the backend mapped in the directory server mapping tree that matches the search criteria.
